(19) United States
(12) Patent Application Publication
(10) Pub. No.: US 2011/0134802 A1
(43) Pub. Date: Jun. 9, 2011

(54) Determining A Routing Tree For Networks With Different Routing Protocols

(75) Inventors: Santosh Rajagopalan, San Francisco, CA (US); Tameen Khan, Los Angeles, CA (US)

(73) Assignee: Cisco Technology, Inc., San Jose, CA (US)

(21) Appl. No.: 12/633,879

(22) Filed: Dec. 9, 2009

(51) Int. Cl. H04L 12/28

(52) U.S. Cl. 370/256; 370/411

(57) ABSTRACT

According to one embodiment, a routing tree may be determined by facilitating communication of a first network and a second network. The first network comprises first switches and uses a first routing protocol, and the second network comprises second switches and uses a second routing protocol. The intersection of the first and second switches comprises gateway switches. A gateway switch enables creation of a second routing tree of the second routing protocol. The second routing tree has virtual links and a virtual root switch representing a first root switch of the first network. The second switches generate minimum link cost tunnels using information from the second routing protocol. A first routing tree of the first routing protocol is extended with the tunnels to merge the first routing tree and the second routing tree.

### TECHNICAL FIELD

The present disclosure relates generally to communication networks.

### BACKGROUND

Networks use routing protocols to route packets through the networks. In certain cases, networks that interface with each other may use different routing protocols. Known techniques for accommodating different routing protocols may include routing all packets flowing from a first network to a second network through a particular gateway switch that forwards the packets to the second network. Forwarding all packets through one switch, however, may not be efficient in certain circumstances. Other known techniques involve modifying at least one of the domain protocols. Modifying a routing protocol, however, may be difficult in certain circumstances.

### BRIEF DESCRIPTION OF THE DRAWINGS

FIG. 1 illustrates an example of a system that includes networks of different routing protocols for which a merged routing tree may be generated.

FIGS. 2 and 3A-3E illustrate an example of a method for generating a merged routing tree.

FIG. 4 illustrates an example of multicast discovery and forwarding.

### DESCRIPTION OF EXAMPLE EMBODIMENTS

### Overview

According to one embodiment, a routing tree may be determined by facilitating communication of a first network and a second network. The first network comprises first switches and uses a first routing protocol, and the second network comprises second switches and uses a second routing protocol. The intersection of the first and second switches comprises gateway switches. A gateway switch enables creation of a second routing tree of the second routing protocol. The second routing tree has virtual links and a virtual root switch representing a first root switch of the first network. The second switches generate minimum link cost tunnels using information from the second routing protocol. A first routing tree of the first routing protocol is extended with the tunnels to merge the first routing tree and the second routing tree.

### DESCRIPTION

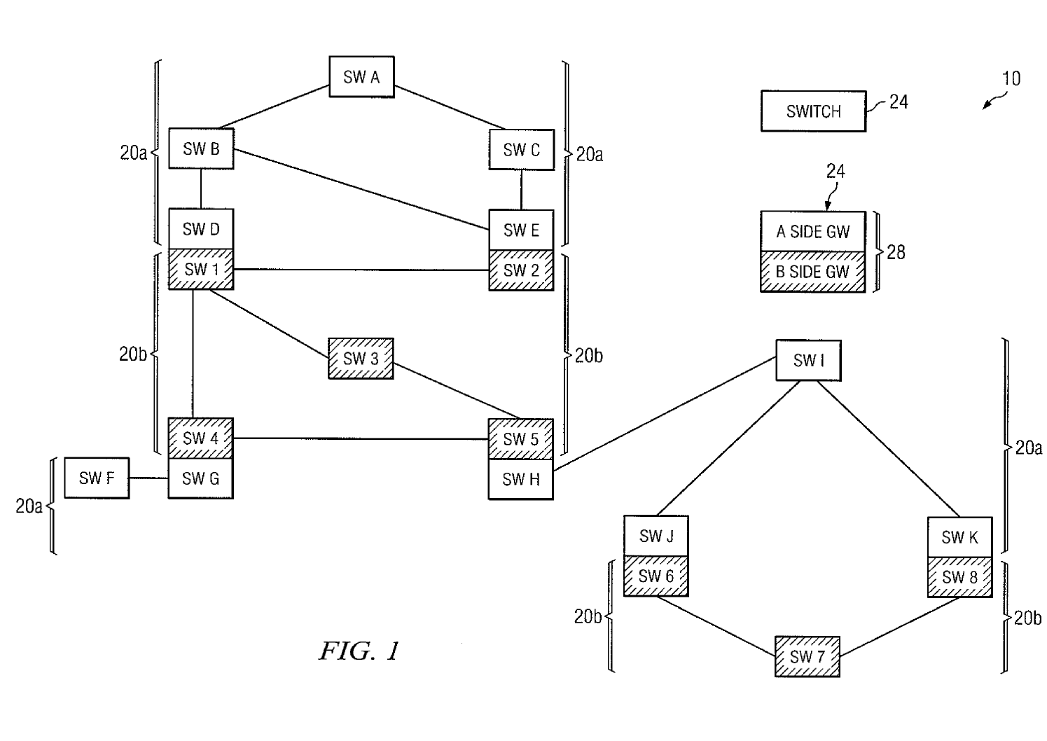

FIG. 1 illustrates an example of a system 10 that includes networks 20 of different routing protocols for which routing trees of the different networks may be merged. In the illustrated embodiment, system 10 includes a plurality of networks 20 (20a-20b) and switches 24 (which include gateway switches 28) coupled as shown. In the embodiment, networks 20 include a first network 20a corresponding to a domain A and a second network 20b corresponding to a domain B. First network 20a operates according to a first routing protocol, and second network 20b operates according to a second routing protocol. First network 20a comprises a set of first switches (labeled with switch identifiers SW X, where X is a letter), and second network 20b comprises a set of second switches (labeled with switch identifiers SW Y, where Y is a number). The intersection of the set of first switches and the set of second switches comprises one or more gateway switches 28.

In one example of operation, a gateway switch 28 enables creation of a second routing tree of the second protocol, where the second routing tree has a virtual root switch that represents a first root switch of first network 20a. The virtual root switch 28 provides information (such as the virtual root switch and virtual links) to allow second network 20b to generate the second routing tree. Second switches 24 are configured to generate minimum link cost tunnels. The tunnels may be used to extend a first routing tree of the first protocol to merge the first routing tree with the second routing tree.

In particular embodiments, network 20 represents a communication network that allows components to communicate with other components. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

In general, network 20 may utilize communication protocols and technologies to provide the communication sessions. Examples of communication protocols and technologies include those set by the Institute of Electrical and Electronics Engineers, Inc. (IEEE) 802.xx standards, the International Telecommunications Union (ITU-T) standards, the European Telecommunications Standards Institute (ETSI) standards, the Internet Engineering Task Force (IETF) standards, or other standards.

In certain embodiments, network 20 may use any of a variety of routing protocols running on different network types, such as Fabric Shortest Path First (FSPF) over a Fibre Channel (FC), Intermediate System to Intermediate System (ISIS) over Data Center Ethernet (DCE), Spanning Tree Protocol (STP) over Classical Ethernet (CE), TRansport Interconnect over Lots of Links (TRILL), or other suitable routing protocol over any suitable network. Domain A and domain B may use any suitable combination of routing protocols, for example, FSPF/ISIS or STP/ISIS.

A switch 24 facilitates communication of one or more networks 20. A switch 24 may be any suitable communication switch (such as a gateway or router) that routes an incoming packet from an input path to a particular output path. A gateway switch 28 is a type of switch 24 that operates as an interface between networks 20. A gateway switch 28 may support different routing protocols of different networks, and may translate from one protocol to another protocol. In certain embodiments, gateway switches 28 creates tunnels that are used by the first routing protocol and presents information that switches 24 of the first and second routing protocols may use to create routing trees. Each switch 24 may independently create a routing tree.

A component of the systems and apparatuses disclosed herein may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

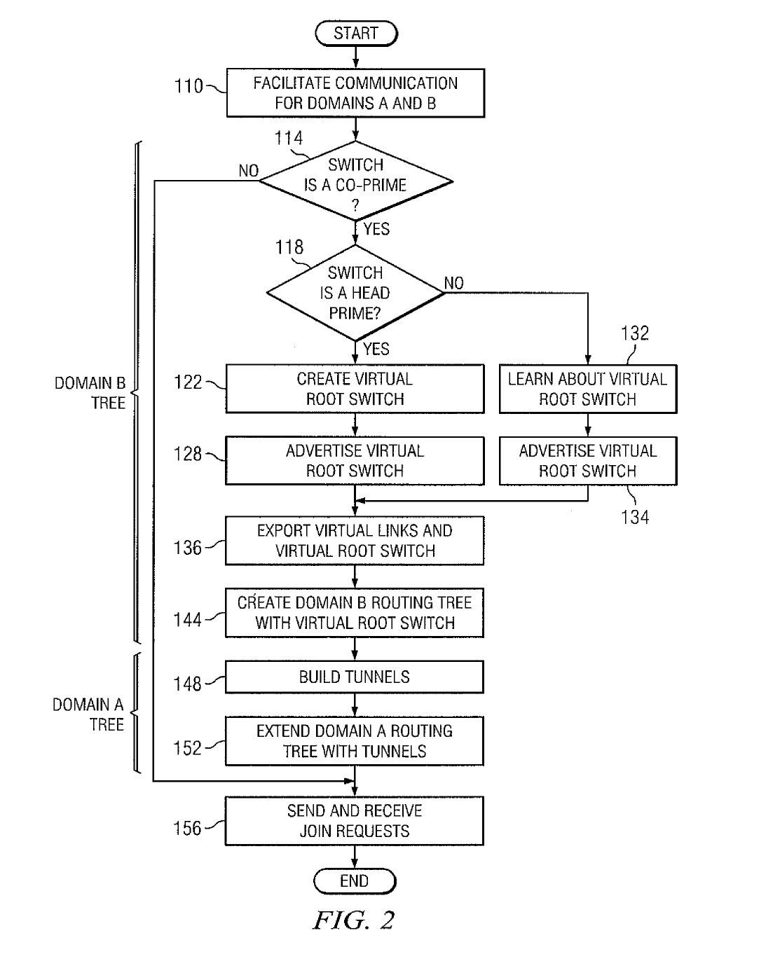

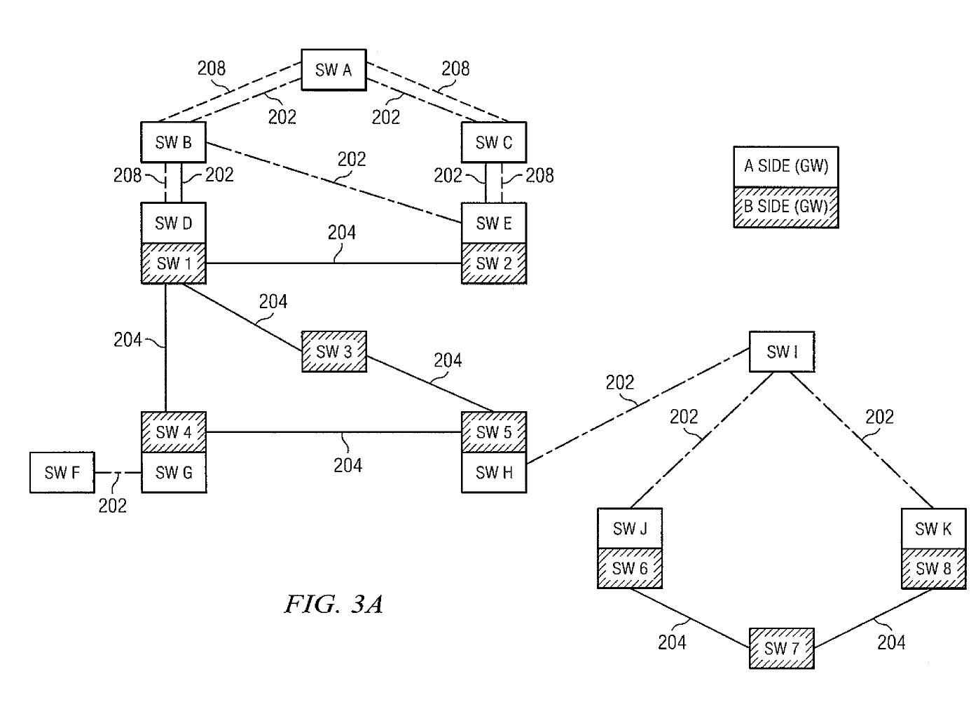

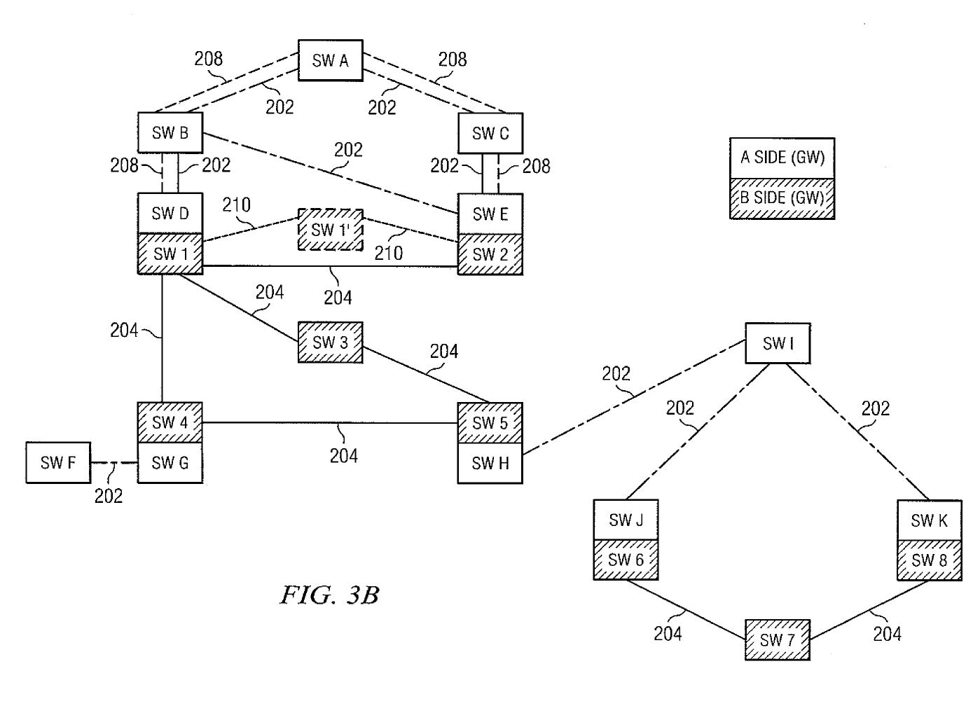

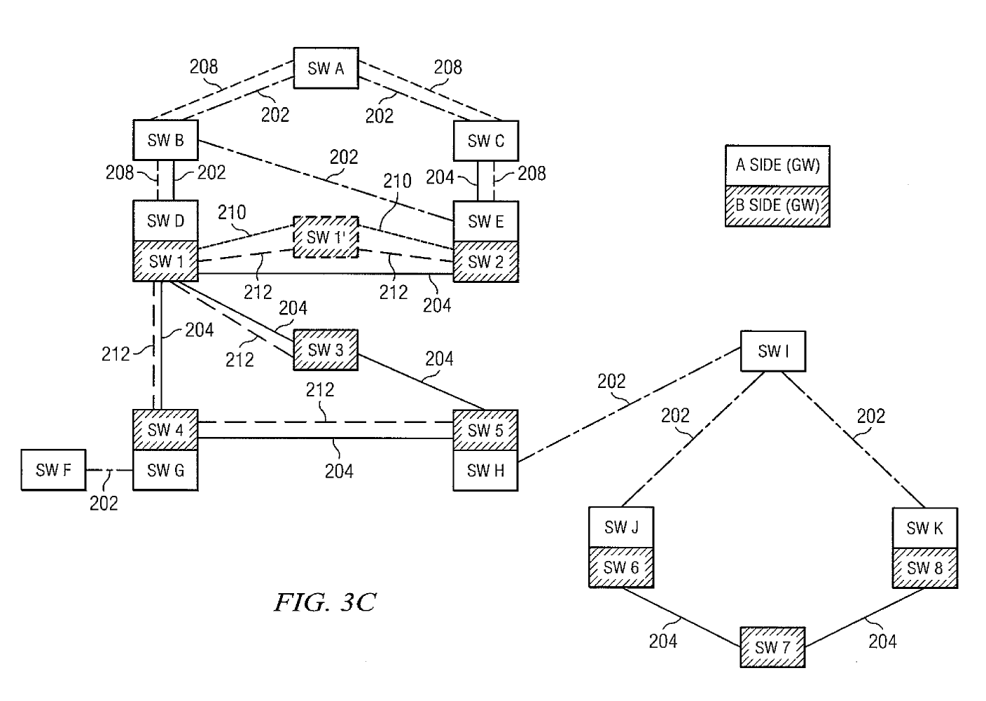

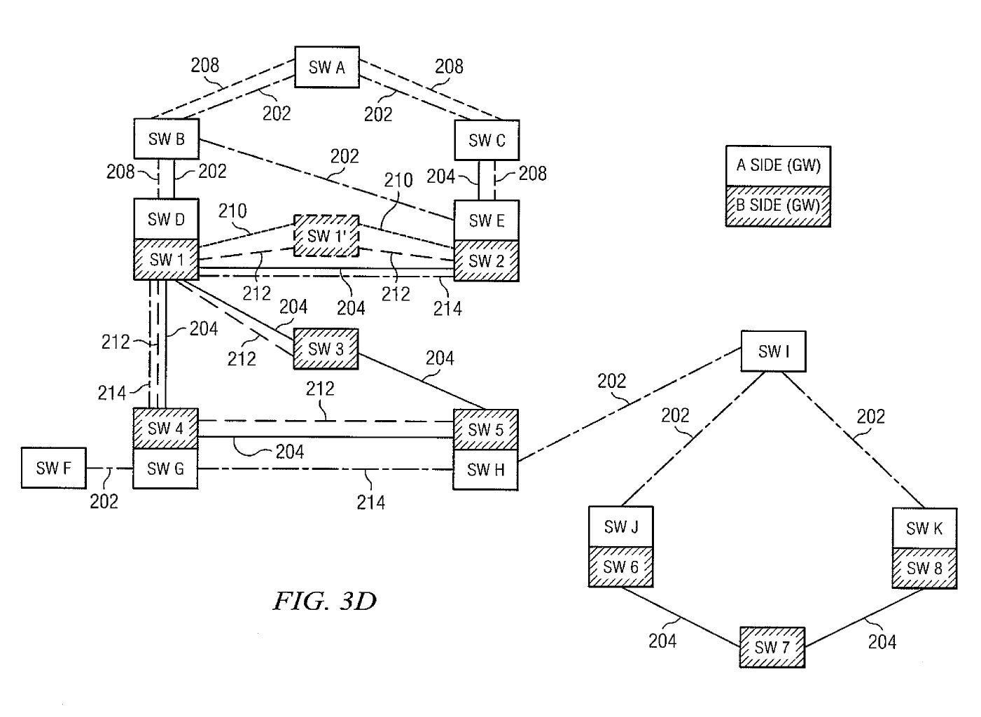

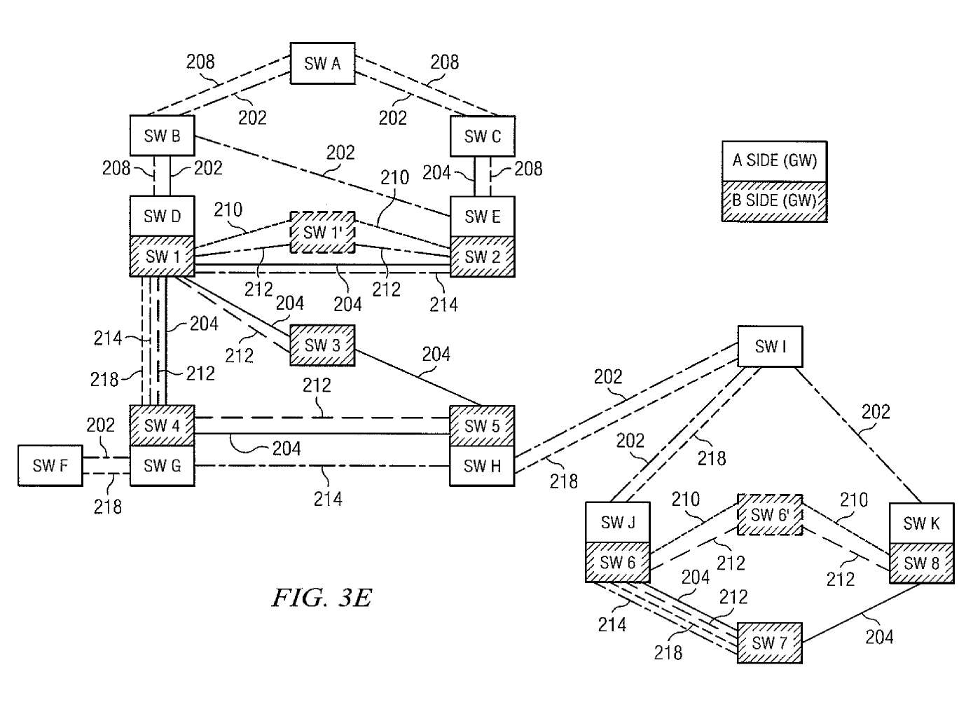

FIGS. 2 and 3A-3E illustrate an example of a method for generating a merged routing tree that may be performed by switches 24, such as gateway switches 28. In the example, domain A operates according to a domain A routing protocol, and domain B operates according to a domain B routing protocol, where the domain A routing protocol is different from the domain B routing protocol. A protocol module, which may be located in a switch 24, may perform operations according to a routing protocol. Domain A has domain A switches 24, and domain B has domain B switches 24. Domain A switches 24 are linked by domain A links 202, and domain B switches 24 are linked by domain B links 204.

In certain embodiments, switches 24 may build a routing tree that represents routing of packets. A routing tree may indicate where packets are to be forwarded. For example, packets received from or destined for a particular switch are to be forwarded to a particular switch. A routing tree may have any suitable routing rules. For example, a packet that is received along a particular path is not forwarded back to the same path. A routing tree may have a root that serves as a reference node with respect to which other nodes are referenced. A routing tree may be generated according to any suitable path determination protocol, for example, a shortest path determination protocol.

In certain embodiments, a switch 24 maintains routing information that includes a link cost set:

{<Sᵢ, Sₖ, Cᵢ>_{i=1 . . . n}}_{k=1 . . . n}

where Sᵢ and Sₖ represent gateway switches, and Cᵢ represents the link cost to reach Sₖ using Sᵢ according to a routing tree. In certain embodiments, switch 24 may look up the link cost that switch 24 and/or another switch may have to a particular destination. In other embodiments, switches 24 may share routing information that describes link cost with each other.

In the example, domain A switches 24 build a routing tree 208 that represents routing in domain A. In the example, switch SW A is the root switch of the domain A routing tree 208. Prior to execution of the method, domain A routing tree 208 stops at the gateway switches SW D/1 and SW E/2, since domain A does not yet have visibility into domain B.

The method starts at step 110, where switches 24 facilitate communication for a first network 20a of domain A and a second network 20b of domain B. Steps 114 through 142 describe creation of a domain B routing tree. The domain B routing tree has a virtual root switch representing a first root switch of the domain A routing tree, where the virtual root switch is a minimum link cost neighbor of one of more second switches 24.

Each gateway switch 28 determines if gateway switch 28 is a “co-prime gateway switch” (or “co-prime”) at step 114 (FIG. 3A). A gateway switch 28 may be a co-prime if there is a route between the gateway switch 28 and the root switch (SW A) of the domain A routing tree. In the example, switches SW D/1 and SW E/2 are co-primes, but switches SW G/4, SW H/5, SW J/6, and SW KM are not. If a gateway switch 28 is a co-prime, the method proceeds to step 118 for the gateway switch 28. If a gateway switch 28 is not a co-prime, the method proceeds to step 156 for the gateway switch 28.

A co-prime may be selected as a head prime gateway switch (or “head prime”) at step 118. The head prime creates a virtual root switch for the domain B routing tree and may be selected in any suitable manner. For example, a co-prime switch 28 with a particular switch identifier, for example, the lowest switch identifier, may be selected as the head prime switch. In the illustrated example, switch SW D/SW 1 may be selected as the head prime switch. If a gateway switch 28 is a head prime, the method proceeds to step 122 for the gateway switch 28. If a gateway switch 28 is not a head prime, the method proceeds to step 132 for the gateway switch 28.

The head prime creates a virtual root switch at step 122 (FIG. 3B). The head prime switch may create the virtual root switch by allocating a virtual switch identifier corresponding to the first root switch. In the illustrated example, the virtual root switch is labeled SW P. A head prime advertises the virtual root switch as a neighbor at step 128. The virtual root switch may be advertised as linked to the head prime by a virtual link 210 that has a minimum link cost (a “minimum cost link”) according to the domain B protocol. Accordingly, domain B may prefer virtual link 210. Virtual link 210 need not be the only link with a minimum link cost, just a link with a minimum link cost. A co-prime learns about the virtual root switch at step 132. A co-prime advertises the virtual root switch as a neighbor linked by a minimum cost link at step 134.

The head prime and the co-primes export virtual links 210 and the virtual root switch to the domain B routing protocol modules of domain B switches 24 at step 136. A domain B routing protocol module creates a domain B tree with the virtual root switch as the root (FIG. 3C) at step 144. The domain B routing protocol module treats virtual links 210 as domain B links and determines a set of paths using the virtual root switch as the root. The paths may be determined using, for example, a Shortest Path First algorithm. Each domain B routing protocol module informs its peers about virtual links 210 using its established protocol.

Steps 114 through 142 may be performed in any suitable manner. In certain embodiments, the virtual root switch may be created by running a virtual instance of the domain B routing protocol within the context of the virtual root switch and adding virtual links to the virtual root switch. The paths generated by the virtual routing protocol instance may be fed directly to a real instance of the domain B routing protocol. In other embodiments, a gateway switch 28 may generate least shortest paths from the virtual root switch to the gateway switch 28. Gateway switch 28 may then provide the paths to the domain B routing protocol module at the gateway switch 28.

The domain B routing tree has been created. The domain A routing protocol module, however, does not yet have knowledge of switches 24 that lie beyond the co-primes. Steps 148 through 152 describe extending a domain A routing tree to merge the routing trees. Domain B switches 24 (such as co-primes) build tunnels 214 to gateway switches 28 at step 148 (FIG. 3D), Tunnels may be uni- or bi-directional, and may be built in any suitable manner. In certain embodiments, a domain B gateway switch 28 identifies whether a domain B switch 24 has a minimum cost link to the gateway switch 28 according to the domain B routing tree. If so, a tunnel is built between domain B gateway switch 28 and the domain B switch 24. For example, from the link cost set, gateway switch S determines, for each Sₖ, a minimum link cost set comprising switches that have the least cost to reach Sₖ:

{<Sᵢ, Sₖ, Cᵢ|_{c=c(mink)}>_{i=1-y}}ₖ₌₁₋ₙ

Each switch of the minimum link cost set may build a tunnel to the switch Sₖ. Gateway switch S may facilitate these processes. In certain embodiments, a tunnel to a gateway switch 28 in domain B does not pass through another gateway switch 28. The tunnels are presented to domain A's routing protocol module as virtual links.

The domain A routing protocol module extends the domain A routing tree to include the tunnels to traverse domain B at step 152. The domain A routing tree may be extended using any suitable algorithm, such as the Shortest Path Discovery algorithm. The two routing trees have effectively merged without changing the basic operation of either the domains or the routing protocols.

Switches 24 send and receive join requests at step 156. When a requested switch 24 receives a join request from a requesting switch 24, the requested switch 24 looks to the merged routing tree to determine the route to the requesting switch 24.

There may be a change in routing information at step 160. If there is a change, the method returns to step 114 to update the merged tree. For example, an outdated link from a previous iteration no longer corresponds to minimum cost link according to the merged tree. The outdated link may be removed, and/or a tunnel associated with the outdated link may be removed. If there is no change, the method terminates.

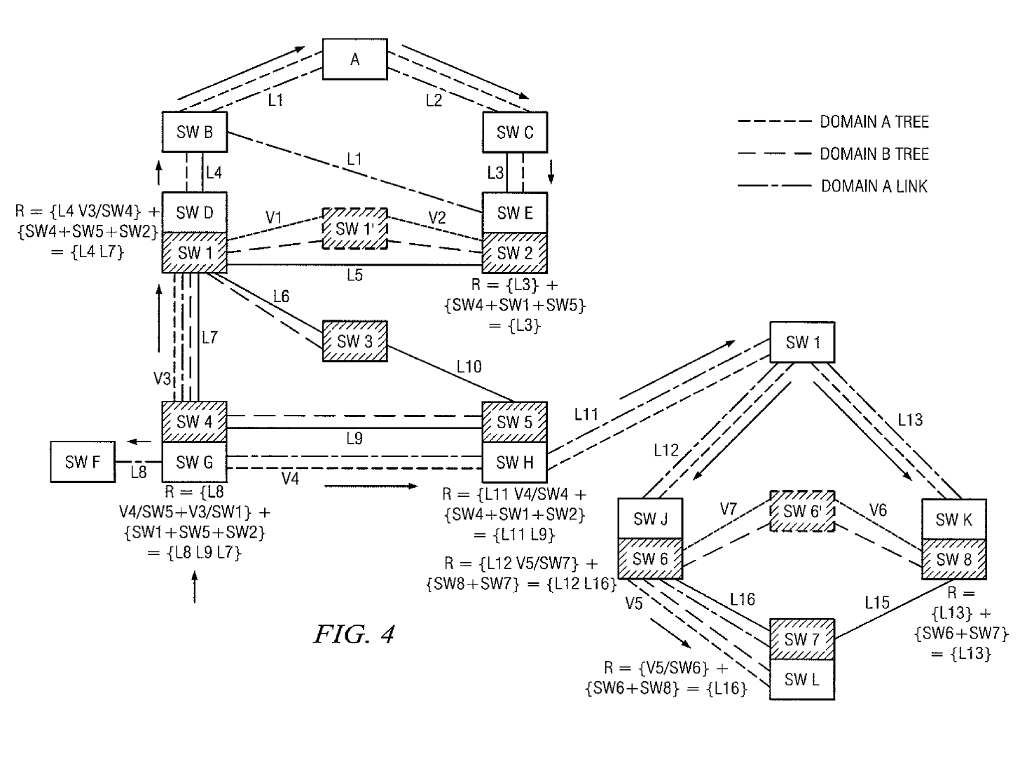

FIG. 4 illustrates an example of multicast discovery and forwarding. In the illustrated example, R represents the set of receivers to which a gateway switch 28 sends a packet. In the example, a gateway switch 28 does not forward a packet along the path on which the packet was received. In the illustrated example, gateway switch SW 4/G receives a packet and forwards the packet along paths L8, L9, and L7. Switch SW D/1 receives the packet and forwards the packet along paths L4 and L7.

Gateway switch SW E/2 receives the packet along path L3. Since the packet was received along path L3, switch SW E/2 does not forward the packet along path L3. Gateway switch SW 5/H receives the packet and sends the packet along path L11. Since the packet was received along path L9, switch SW 5/H does not forward the packet along path L9. Switch SW J/6 receives the packet along path L12 and sends the packet along path L16. Switch SW 7/L receives the packet along path L16. Switch SW K/8 receives the packet along path L13.

Modifications, additions, or omissions may be made to the systems, apparatuses, and methods disclosed herein without departing from the scope of the invention. The components of the systems may be integrated or separated. Moreover, the operations of the systems may be performed by more, fewer, or other components. Additionally, operations of the systems may be performed using any suitable logic comprising software, hardware, and/or other logic. The methods may include more, fewer, or other steps. Additionally, steps may be performed in any suitable order. As used in this document, “each” refers to each member of a set or each member of a subset of a set. A set may include zero, one, or more elements. A subset of a set may include zero, one, two or more, or all elements of the set.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
facilitating communication of a first network and a second network, the first network operating according to a first routing protocol, the second network operating according to a second routing protocol, the first network comprising a set of first switches, the second network comprising a set of second switches, an intersection of the set of first switches and the set of second switches comprising one or more gateway switches;
enabling, by a gateway switch, creation of a second routing tree of the second routing protocol, the second routing tree having one or more virtual links and a virtual root switch representing a first root switch of the first network, the virtual root switch being a minimum link cost neighbor of one or more second switches;
providing the virtual links and the virtual root switch to the second network, the second switches configured to generate one or more minimum link cost tunnels using information from the second routing protocol; and
extending a first routing tree of the first routing protocol with the tunnels to merge the first routing tree and the second routing to yield a merged routing tree.

2. The method of claim 1, a second switch configured to:
identify one or more second switches that have a minimum link cost to a second gateway switch according to the second routing protocol; and
build the tunnels, each tunnel between the second gateway switch and an identified second switch.

3. The method of claim 1, the enabling creation of the second routing tree further comprising:
determining that there is a route to the first root switch of the first network;
creating the second routing tree; and
advertising that the virtual root switch is a neighbor with a minimum link cost.

4. The method of claim 1, the enabling creation of the second routing tree further comprising:
determining that there is a route to the first root switch of the first network;
receiving notification about the virtual root switch; and
advertising that the virtual root switch is a neighbor with a minimum link cost.

5. The method of claim 1, further comprising:
determining that an outdated link from a previous iteration is no longer a minimum cost link according to the merged tree; and
removing the outdated link.

6. The method of claim 1, further comprising:
determining that an outdated link from a previous iteration is no longer a minimum cost link according to the merged tree; and
removing a tunnel associated with the outdated link.

7. The method of claim 1, further comprising:
receiving a join request from a requesting switch; and
determining a route to the requesting switch according to the merged tree.

8. An apparatus comprising:
a memory configured to store computer executable instructions; and
one or more processors coupled to the memory, the processors configured, when executing the instructions, to:
facilitate communication of a first network and a second network, the first network operating according to a first routing protocol, the second network operating according to a second routing protocol, the first network comprising a set of first switches, the second network comprising a set of second switches, an intersection of the set of first switches and the set of second switches comprising one or more gateway switches;
enable creation of a second routing tree of the second routing protocol, the second routing tree having one or more virtual links and a virtual root switch representing a first root switch of the first network, the virtual root switch being a minimum link cost neighbor of one or more second switches;
provide the virtual links and the virtual root switch to the second network, the second switches configured to generate one or more minimum link cost tunnels using information from the second routing protocol; and
extend a first routing tree of the first routing protocol with the tunnels to merging the first routing tree and the second routing tree to yield a merged routing tree.

9. The apparatus of claim 8, a second switch configured to:
identify one or more second switches that have a minimum link cost to a second gateway switch according to the second routing protocol; and
build the tunnels, each tunnel between the second gateway switch and an identified second switch.

10. The apparatus of claim 8, the processors configured to enable creation of the second routing tree by:
determining that there is a route to the first root switch of the first network;
creating the second routing tree; and
advertising that the virtual root switch is a neighbor with a minimum link cost.

11. The apparatus of claim 8, the processors configured to enable creation of the second routing tree by:
determining that there is a route to the first root switch of the first network;
receiving notification about the virtual root switch; and
advertising that the virtual root switch is a neighbor with a minimum link cost.

12. The apparatus of claim 8, the processors configured to:
determine that an outdated link from a previous iteration is no longer a minimum cost link according to the merged tree; and
remove the outdated link.

13. The apparatus of claim 8, the processors configured to:
determine that an outdated link from a previous iteration is no longer a minimum cost link according to the merged tree; and
remove a tunnel associated with the outdated link.

14. The apparatus of claim 8, the processors configured to:
receive a join request from a requesting switch; and
determine a route to the requesting switch according to the merged tree.

15. A method comprising:
facilitating communication of a first network and a second network, the first network operating according to a first routing protocol, the second network operating according to a second routing protocol, the first network comprising a set of first switches, the second network comprising a set of second switches, an intersection of the set of first switches and the set of second switches comprising one or more gateway switches;
receiving from the first network one or more virtual links and a virtual root switch of a second routing tree of the second routing protocol, the virtual root switch representing a first root switch of the first network, the virtual root switch being a minimum link cost neighbor of one or more second switches;
generating one or more minimum link cost tunnels using information from the second routing protocol; and
facilitating extension of a first routing tree of the first routing protocol with the tunnels to merge the first routing tree and the second routing tree to yield a merged routing tree.

16. The method of claim 15, further comprising:
identifying one or more second switches that have a minimum link cost to a second gateway switch according to the second routing protocol; and
building the tunnels, each tunnel between the second gateway switch and an identified second switch.

17. The method of claim 15, further comprising:
determining that an outdated link from a previous iteration is no longer a minimum cost link according to the merged tree; and
removing a tunnel associated with the outdated link.

18. An apparatus comprising:
a memory configured to store computer executable instructions; and
one or more processors coupled to the memory, the processors configured, when executing the instructions, to:
facilitate communication of a first network and a second network, the first network operating according to a first routing protocol, the second network operating according to a second routing protocol, the first network comprising a set of first switches, the second network comprising a set of second switches, an intersection of the set of first switches and the set of second switches comprising one or more gateway switches;
receive from the first network one or more virtual links and a virtual root switch of a second routing tree of the second routing protocol, the virtual root switch representing a first root switch of the first network, the virtual root switch being a minimum link cost neighbor of one or more second switches;
generate one or more minimum link cost tunnels using information from the second routing protocol; and
facilitate extension of a first routing tree of the first routing protocol with the tunnels to merge the first routing tree and the second routing tree to yield a merged routing tree.

19. The apparatus of claim 18, the processors configured to:
identify one or more second switches that have a minimum link cost to a second gateway switch according to the second routing protocol; and
build the tunnels, each tunnel between the second gateway switch and an identified second switch.

20. The apparatus of claim 18, the processors configured to:
determine that an outdated link from a previous iteration is no longer a minimum cost link according to the merged tree; and
remove a tunnel associated with the outdated link.
